(19) United States
(12) Patent Application Publication
(10) Pub. No.: US 2024/0383156 A1
(43) Pub. Date: Nov. 21, 2024

(54) AUTOMATIC COUPLING DEVICE

(71) Applicant: FEDEGARI AUTOCLAVI S.P.A., ALBUZZANO (IT)

(72) Inventors: Giuseppe FEDEGARI, PAVIA (IT); Paolo FEDEGARI, CELERINA/SCLARIGNA (CH)

(73) Assignee: FEDEGARI AUTOCLAVI S.P.A., ALBUZZANO (IT)

(21) Appl. No.: 18/578,968

(22) PCT Filed: Jul. 8, 2022
(86) PCT No.: PCT/IB2022/056321

§ 371 Date: Jan. 12, 2024

(30) Foreign Application Priority Data
Jul. 12, 2021 (IT) 102021000018248

(51) Int. Cl. B25J 15/02; B25J 15/00

(52) U.S. Cl. CPC B25J 15/0273; B25J 15/0047

(57) ABSTRACT

An automatic coupling device comprising a first coupling body and a second coupling body respectively mountable on a first body, preferably a robotic arm, and on a second body, preferably a reservoir adapted to contain at least one sterile product to be transferred to a filling line, so as to form a kinematic coupling between the first body and the second body. The device further comprises constraining means activatable on respective constraining portions of the first coupling body and the second coupling body so as to reversibly constrain the first body and the second body. In particular, the first coupling body comprises locking means operatively connected to the second coupling body to prevent and/or permit a relative movement between the first coupling body and the second coupling body. Furthermore, the device comprises movement means configured to produce a relative movement between the first coupling body and the second coupling body and a control unit configured to activate and/or deactivate at least the movement means and/or the constraining means and/or locking means on the basis of at least one operating parameter of said device and/or on the basis of a preloaded logic.

### TECHNICAL FIELD

The present invention relates to an automatic coupling device.

In particular, the present invention relates to the technical field of devices that permit the production of kinematic constraints between two or more bodies so as to ensure a safe and controlled movement of at least one of them.

For example, the invention can find broad application in coupling systems adapted to couple a movement device, for example a mechanised arm, and a containment body or the like so as to permit a movement thereof through a plurality of different operating stations.

In particular, the present invention allows the coupling of a robotic arm with a reservoir adapted to contain at least one sterile product to be transferred, for example, from an autoclave to a filling line.

### PRIOR ART

In some production sectors, such as the chemical and/or pharmaceutical sector, there is often the need to move treated products, for example a plurality of caps for vials or containers sterilised in an autoclave, from the station in which the treatment occurs to a station of use, for example a filling line in which the caps are applied to the respective containers.

To achieve such movement, the products are placed inside reservoirs of variable dimensions and manually moved by one or more operators to a loading/unloading station near the movement device. At the loading/unloading station, the operator manually connects the movement device and the reservoir, kinematically constraining it thereto so as to permit the subsequent movement towards the station of use.

Disadvantageously, the movement of the reservoir and its correct positioning within the loading/unloading station are particularly difficult due to the structure of the reservoir itself and the overall weight moved.

Disadvantageously, moreover, the connection between the reservoir and the movement device requires particular training in order to create a coupling capable of ensuring total safety in the work environment.

Furthermore, the complicated succession of operations which leads to the creation of such a constraint results in a strong impact on the operating times, inevitably causing an increase in operating costs.

### OBJECT OF THE INVENTION

In this context, the technical task underlying the present invention is to propose an automatic coupling device which obviates the drawbacks of the prior art as cited above.

In particular, it is an object of the present invention to provide an automated coupling device capable of simplifying the kinematic coupling operations between at least a first and a second body.

A further object of the present invention is to provide an automatic coupling device which ensures a greater efficiency in the coupling operations with respect to the devices of the prior art.

A further object of the present invention is to provide an automatic coupling device capable of increasing the safety of the coupling between a first and a second body with respect to the devices of the prior art.

Furthermore, a further object of the present invention is to provide an automatic coupling device having high operational flexibility.

The technical task set and the objects specified are substantially attained by an automatic coupling device, comprising the technical features as set out in one or more of the accompanying claims.

The dependent claims correspond to possible embodiments of the invention

### BRIEF DESCRIPTION OF THE DRAWINGS

Further features and advantages of the present invention will become more apparent from the indicative and thus non-limiting description of a preferred but non-exclusive embodiment of an automatic coupling device, as illustrated in the appended drawings, in which:

FIG. 1 is a perspective view of an automatic coupling device in accordance with a possible embodiment of the present invention;

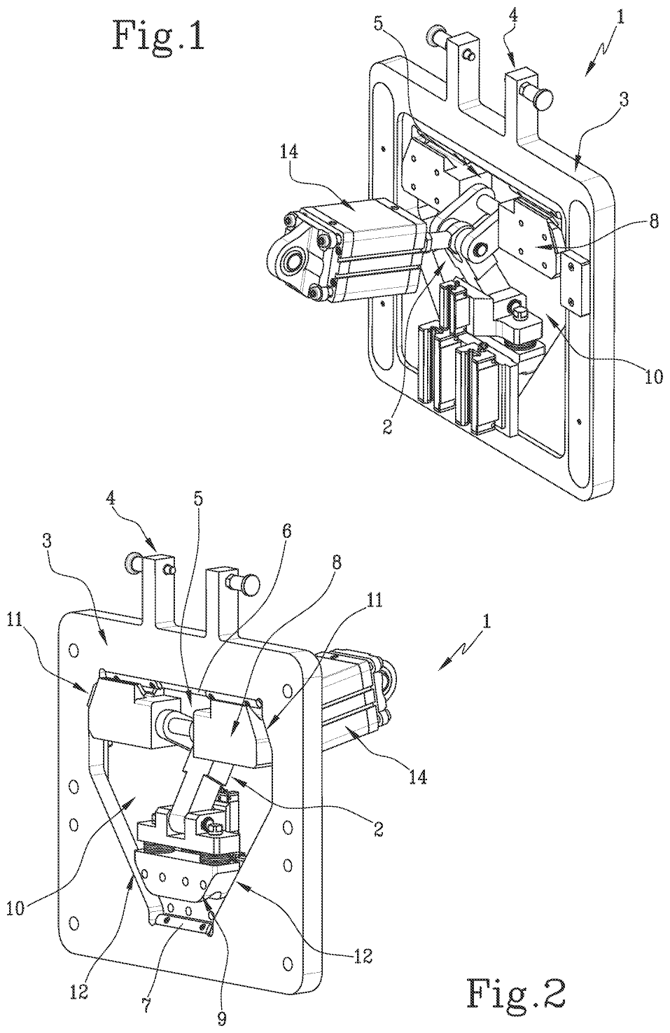

FIG. 2 is a schematic depiction in partial section of the automatic coupling device of FIG. 1;

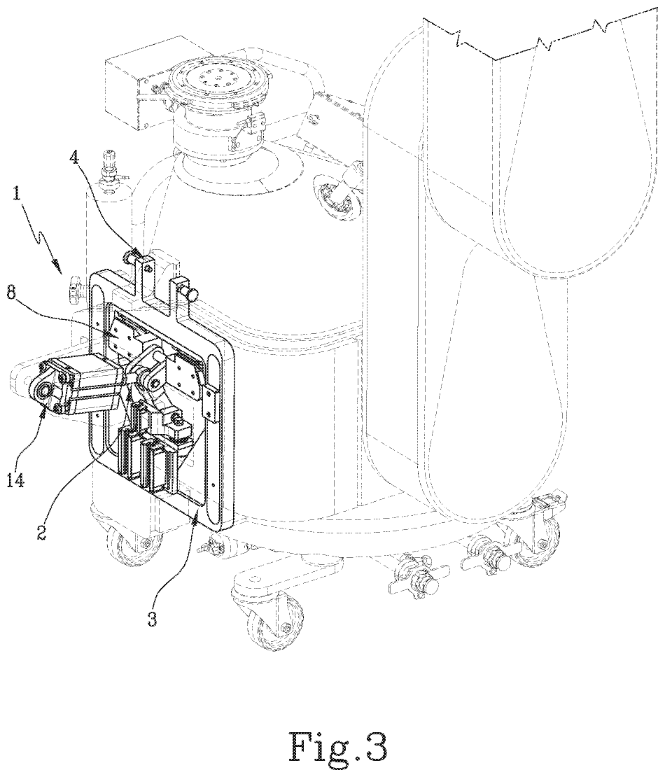

FIGS. 3 and 4 depict respective perspective views from different points of view of the device of FIG. 1 applied to a reservoir depicted in a dotted line;

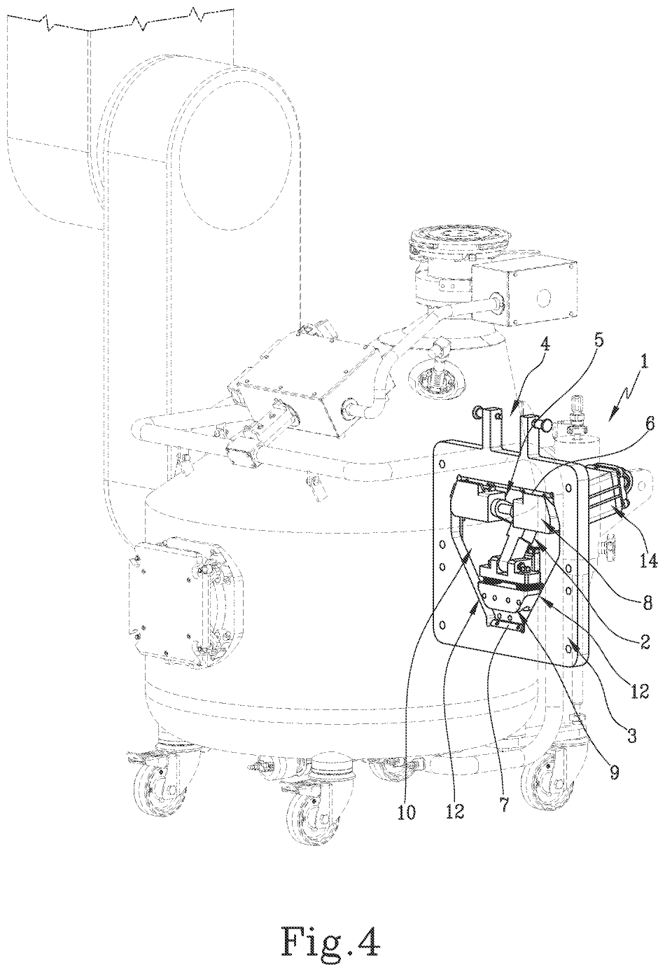

FIG. 5 depicts a detail of the device of FIG. 4;

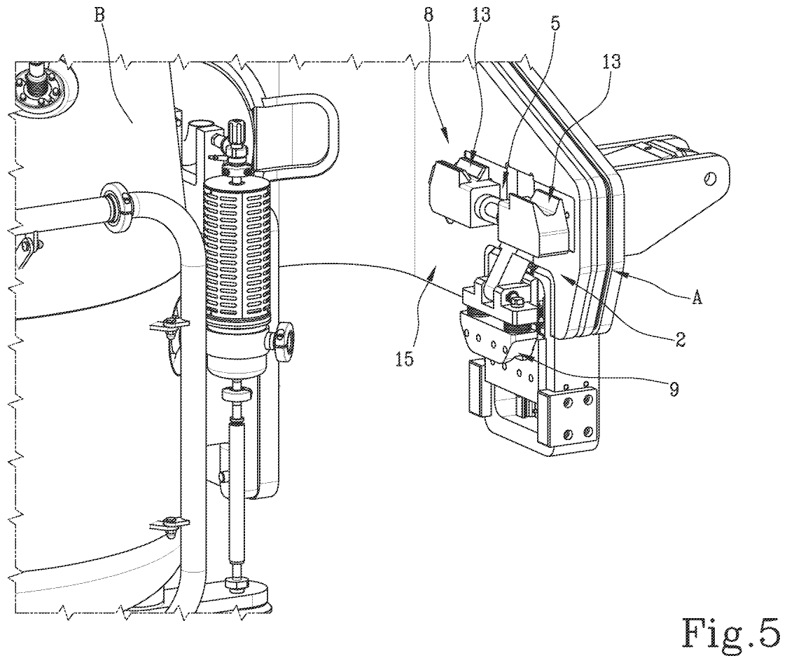

FIG. 6 depicts a lateral view in cross-section of the device of FIG. 1;

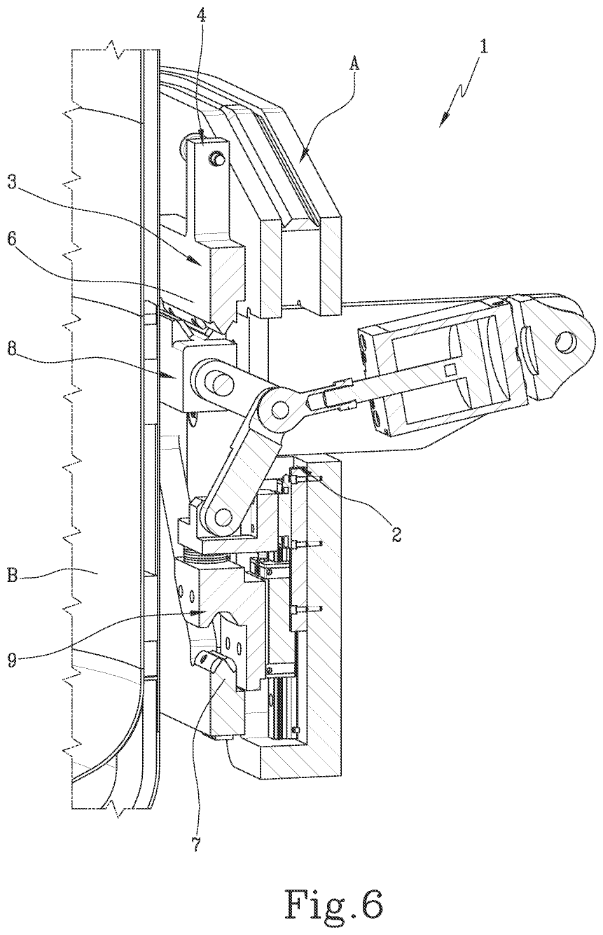

FIG. 7 shows a part of the device of FIG. 1 applied to a reservoir.

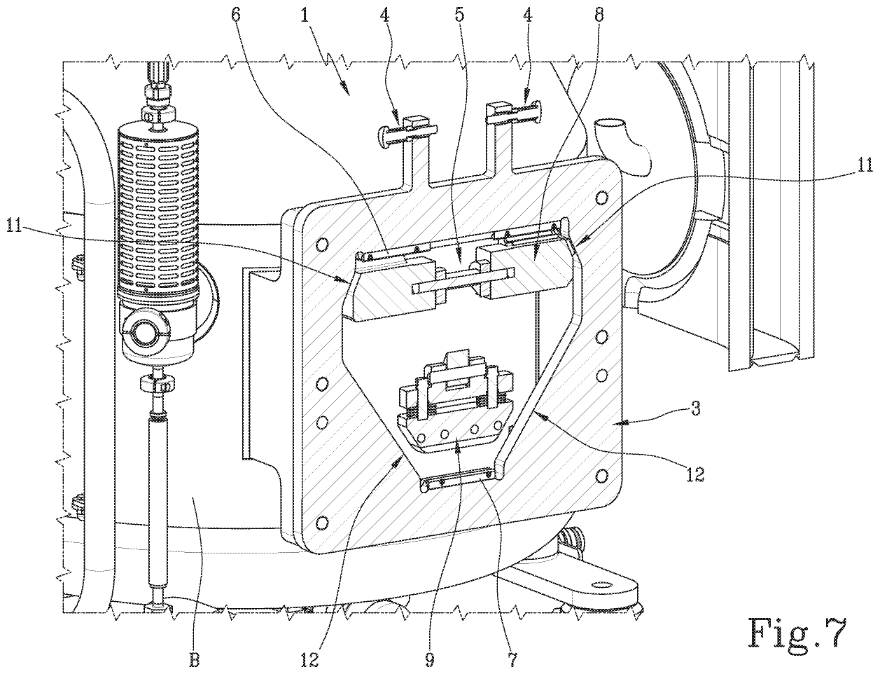

### DETAILED DESCRIPTION OF THE PREFERRED EMBODIMENTS OF THE INVENTION

With reference to the appended drawings, the reference number 1 has been used to generally designate an automatic coupling device, which will be referred to here as device 1 for the sake of simplicity.

In particular, the device 1 is configured to reversibly constrain at least a first body “A” and at least a second body “B” so as to form a kinematic coupling that permits the movement of the aforementioned bodies through a plurality of different operating positions.

In accordance with a possible, purely exemplary and non-limiting embodiment of the present invention, the first body “A” can be a movement device, for example a robotic arm adapted to perform a movement of a reservoir between a loading/unloading station and a filling line, and the second body “B” can be a containment body, for example a reservoir adapted to contain at least one sterile product to be transferred to a filling line.

That is, the first body “A” can be a robotic arm and the second body “B” can be a reservoir, adapted to contain a plurality of sterilised covers or caps, which can be moved by the same robotic arm to transfer the aforementioned covers or caps to a filling line.

The device 1 comprises a first coupling body 2 and a second coupling body 3 respectively mountable on the first body “A” and on the second body “B” to form a kinematic coupling between the first body “A” and the second body “B”.

Advantageously, the device 1 further comprises constraining means 4 activatable on respective constraining portions of the first coupling body 2 and the second coupling body 3 so as to reversibly constrain the first body “A” and the second body “B” so as to be able to ensure the correct mutual position such as to be able to safely start the automatic engagement procedure.

Thereby, the constraining means 4 permits a kinematic coupling between the first body “A” and the second body “B”.

In accordance with a possible embodiment of the present invention, the constraining means 4 can permit a coupling between a robotic arm and a reservoir so that the robotic arm can move the reservoir through a plurality of operating positions, for example between a loading/unloading station and a filling line.

Advantageously, the constraining means 4 can comprise at least one quick-fit connection so as to allow a faster and simpler connection and/or disconnection between the first body “A” and the second body “B” with respect to the devices of the prior art.

For example, the constraining means 4 can comprise a spring-loaded shutter mounted on the second coupling body 3 and/or a centring block mounted on the first coupling body 2 operatively connected to substantially engage the first coupling body 2 and the second coupling body 3.

In accordance with further possible embodiments not illustrated in the appended drawings, the spring-loaded shutter can be mounted on the first coupling body 2 and/or the centring block can be mounted on the second coupling body 3 and/or the aforementioned spring-loaded shutter and centring block can be not included, without altering the inventive concept underlying the present invention.

For example, the first coupling body 2 can be made in the form of, or be connected to, a manipulator and the second coupling body 3 can be made in the form of a plate applicable to a reservoir.

As illustrated in the appended drawings, the first coupling body 2 comprises locking means 5 operatively connected to the second coupling body 3 to prevent and/or permit a relative movement between the first coupling body 2 and the second coupling body 3.

Furthermore, the second coupling body 3 defines at least a first locking portion 6 and at least a second locking portion 7 respectively adapted to abuttingly receive respective portions of the locking means 5 to prevent a relative movement between the first coupling body 2 and the second coupling body 3.

That is, the locking means 5 and the locking portions 6, 7 assist the constraining means 4 in the production of a kinematic coupling between the first body “A” and the second body “B”. In particular, the locking means 5 and the locking portions 6, 7 are operatively connected to kinematically constrain the first coupling body 2 and the second coupling body 3.

The locking means 5 comprises first locking means 8 and second locking means 9.

In particular, the first locking means 8 and the second locking means 9 are mutually movable between an active configuration, in which the first locking means 8 and the second locking means 9 are respectively abutting on the first locking portion 6 and on the second locking portion 7 to prevent a relative movement between the first body “A” and the second body “B”, and a rest configuration, in which the first locking means 8 and the second locking means 9 are not respectively abutting on the first locking portion 6 and/or on the second locking portion 7 permitting a relative movement between the first body “A” and the second body “B”.

In accordance with a possible embodiment of the present invention which is purely illustrative and not limiting, the first locking means 8 can be fixed to a manipulator, which can be moved up to engaging the reservoir.

Preferably, the first locking portion 6 and the second locking portion 7 are defined by opposing, even more preferably facing, portions of the second locking body 3.

Furthermore, the second coupling body 3 preferably defines at least one opening 10 adapted to receive in at least partial insertion the first locking means 8 and/or the second locking means 9.

In accordance with a possible embodiment and as illustrated in the appended drawings, the first locking portion 6 and the second locking portion 7 can respectively define perimeter portions of the aforementioned opening 10.

For example, the opening 10 can have a polygonal shape, preferably hexagonal, to facilitate the insertion of the first locking means 8 and/or the second locking means 9 and their relative movement.

Preferably, the upper and lower horizontal sides of the hexagon of the opening 10, are rounded while the oblique sides act as a centring guide to the first coupling body 2. The final section of each oblique side ends with a vertical section that allows a lateral containment to be given to the grip.

The first locking means 8 can consist, for example, of two fixed upper hooks, while the second locking means 9 can translate vertically (actuated by a trapezoidal screw motor).

Preferably, the second locking body 9 comprises a first pair of lead-in portions 11 and a second pair of lead-in portions 12 respectively converging towards the first locking portion 6 and the second locking portion 7.

In particular, the first pair of lead-in portions 11 and the second pair of lead-in portions 12 can be configured to guide a movement of the first locking means 8 and the second locking means 9 respectively towards the first locking portion 6 and the second locking portion 7.

Furthermore, the first pair of lead-in portions 11 and/or the second pair of lead-in portions 12 can be defined by opposing perimeter portions of the aforementioned opening 10.

Advantageously, the first locking means 8 and/or the second locking means 9 can have complementarily shaped portions 13 with respect to the first locking portion 6 and/or the second locking portion 7, respectively.

In accordance with a purely exemplary and non-limiting form of the present invention, the complementarily shaped portions 13 can have wedges, protrusions, arcuate portions and/or the like.

Furthermore, the complementarily shaped portions 13 can have rubberised surfaces and/or increased friction coefficient.

Thereby, the device 1 allows to make the coupling between the locking means and the locking portions more effective.

Preferably, the locking means 5 comprises at least one actuator 14 configured to perform a relative movement between the first locking means 8 and the second locking means 9. For example, two or more actuators 14 (not shown in the figures) can be included.

For example, the actuator 14 could comprise a pneumatic piston and/or a pneumatically controlled toggle which are capable of ensuring an efficient and accurate movement of the locking means 5.

In accordance with further possible embodiments not illustrated in the appended drawings, the actuator 14 can be made in accordance with different embodiments without altering the concept underlying the present invention.

Advantageously, the first locking means 8 and/or the second locking means 9 can comprise a recirculating ball block which allows a highly reliable relative movement.

Furthermore, the device 1 comprises a movement means 15 configured to produce a relative movement between the first coupling body 2 and the second coupling body 3.

In particular, the movement means 15 is configured to move the first coupling body 2 and/or the second coupling body 3 at least between a proximal position, in which the constraining means 4 is active on respective constraining portions of the first coupling body 2 and the second coupling body 3, and a distal position, in which the constraining means 4 is not active on respective constraining portions of the first coupling body 2 and the second coupling body 3.

Advantageously, the movement means 15 can be configured to move the first coupling body 2 and/or the second coupling body 3 so that in the aforementioned proximal position the first locking means 8 is arranged abutting on the first locking portion 6. Thereby, the subsequent movement of the second locking means 9 determines the transition of the locking means 5 from the rest configuration to the active configuration, ensuring the locking of the relative movement between the first coupling body 2 and/or the second coupling body 3.

That is, the second locking means 9 can be reversibly movable away from and/or near to the first locking means 8 in order to achieve the active configuration and/or the rest configuration.

In accordance with further possible embodiments of the present invention, the first locking means 8 can be movable with respect to the second locking means 9 and/or both the first locking means 8 and the second locking means 9 can be movable to produce a relative movement without altering the inventive concept underlying the present invention.

Preferably, the movement means 15 comprises at least one robotic arm adapted to move the first coupling body 2 and/or the second coupling body 3 at least between the proximal position and the distal position.

In accordance with a possible, purely demonstrative and non-limiting embodiment, the aforementioned robotic arm is connected to the first coupling body 2.

The device 1 further comprises a control unit (not illustrated in the appended drawings) configured to activate and/or deactivate at least the movement means 15 and/or the constraining means 4 and/or locking means 5 on the basis of at least one operating parameter of the device 1 and/or on the basis of a preloaded logic.

Advantageously, the device 1 comprises at least one sensor (not illustrated in the appended drawings) adapted to detect and generate at least one signal representative of at least one operating parameter of the same device 1 and send the signal to the aforementioned control unit.

Preferably, the at least one sensor is configured to detect at least one relative positioning between the first coupling body 2 and the second coupling body 3.

Advantageously, this positioning can be ensured by the presence of the constraining means 4.

In particular, the at least one sensor can comprise at least one photocell that permits detecting the relative positioning between the first coupling body 2 and the second coupling body 3 and/or the volumetric dimensions induced by the first coupling body 2 and/or by the second coupling body 3. Furthermore, the at least one sensor can comprise at least one load cell and/or at least one accelerometer operatively connected to the control unit so as to make a plurality of operating parameters available which facilitate the device 1 in the relative movement of the first body “A” and the second body “B”.

That is, the control unit can be configured at least to actuate the movement means 15 and/or the aforementioned robotic arm to produce a relative movement between the first coupling body 2 and the second coupling body 3. Furthermore, the control unit can be configured at least to promote a reversible movement of the locking means 5 between the active configuration and the rest configuration. Furthermore, the control unit can be configured at least to activate and/or deactivate the constraining means 4 to constrain and/or free the first body “A” and the second body “B”.

In particular, the control unit can be configured to perform one or more of the aforementioned tasks on the basis of at least one operating parameter of the device 1 and/or on the basis of a preloaded logic.

Advantageously, the control unit can be configured to carry out one or more of the aforementioned tasks automatically.

According to further possible embodiments of the present invention not illustrated in the appended drawings, the constraining means 4 is manually unlocked without the inventive concept underlying the present invention being altered.

In accordance with a possible embodiment of the present invention, the device 1 can be configured to determine the positioning of the second body “B”, promote a movement of the first coupling body 2 towards the second coupling body 3 and/or activate the constraining means 4 and/or the locking means 5 to produce a coupling and/or a decoupling between the first body “A” and the second body “B” automatically.

That is, the device 1 can carry out one or more of the aforementioned tasks without requiring the intervention of an operator, overcoming the need for qualified personnel and minimising the fixed operating costs.

In accordance with a possible, purely exemplary and non-limiting embodiment of the present invention, the first coupling body 2 is connected to a robotic arm and the second coupling body 3 is connected to a reservoir.

The reservoir can be manually approached to the first coupling body 2 until the constraining means 4, for example a pair of spring pins arranged on the second coupling body 3, engage in a substantially automatic manner in a special receptacle, making the first coupling body 2 and the second coupling body 3 solidal.

The engagement condition of the constraining means 4 permits the control of the correct positioning of the reservoir with respect to the first coupling body 2.

In particular, a special sensor arranged in the first coupling body 2 permits verifying the correctness of the mutual positioning between the first coupling body 2 and the second coupling body 3.

Such a condition, verified by virtue of the presence of the aforementioned sensor, permits starting the automatic engagement cycle.

In particular, the first coupling body 2, moved by the movement means 15, allows the reservoir to be lifted to a certain height from the ground, for example a few millimetres from the ground, until a second sensor arranged in the first coupling body 2 detects the correct positioning so as to allow the control unit to continue the locking action by moving the first locking means 8 and/or the second locking means 9 until the engagement is obtained by virtue of the activation of the actuator 14.

A further sensor detects at least one operating parameter related to the achievement of a locking condition so that the control unit permits starting the movement of the reservoir.

The movement means 15 can safely lift the reservoir with its load of sterile products until the unloading door present in the filling line is reached. After use, the reservoir can be repositioned on the ground.

The constraining means 4 can be manually unlocked by an operator so as to free the reservoir from the first coupling body 2.

Finally, the reservoir, freed from the first coupling body 2, can be moved manually by an operator.

It is thus noted that the present invention achieves the proposed objects by making an automated coupling device capable of simplifying the kinematic coupling operations between at least a first and a second body by virtue of the presence of a control unit configured to activate and/or deactivate at least the movement means and/or the constraining means and/or the locking means on the basis of at least one operating parameter of the device and/or on the basis of a preloaded logic.

Advantageously, the present invention provides an automatic coupling device which ensures a greater efficiency in the coupling operations with respect to the devices of the prior art, overcoming the need for specialised operators for carrying out the aforementioned operations.

Advantageously, the present invention provides an automatic coupling device capable of increasing the safety of the coupling between a first and a second body with respect to the devices of the prior art by virtue of the presence of locking means that assist the constraining means in the production of the kinematic coupling.

1. An automatic coupling device configured to reversibly constrain at least a first body and at least a second body and comprising:
a first coupling body and a second coupling body respectively mountable on a first body and on a second body, so as to form a kinematic coupling between the first body and the second body;
constraining means activatable on respective constraining portions of said first coupling body and said second coupling body so as to reversibly constrain the first body and the second body;
wherein said first coupling body comprises locking means operatively connected to said second coupling body so as to prevent and/or permit a relative movement between said first coupling body and said second coupling body;
wherein said second coupling body defines at least a first locking portion and at least a second locking portion respectively adapted to abuttingly receive respective portions of said locking means so as to prevent a relative movement between said first coupling body and said second coupling body;
and wherein said locking means comprises a first locking means and a second locking means that are reciprocally movable between an active configuration, in which said first locking means and said second locking means are respectively abutting on said first locking portion and said second locking portion so as to prevent a relative movement between the first body and the second body, and a rest configuration, in which said first locking means and second locking means are not respectively abutting on said first locking portion and/or said second locking portion, thus permitting a relative movement between the first body and the second body;
a movement means configured to produce a relative movement between said first coupling body and said second coupling body; said movement means being configured to move said first coupling
body and said second coupling body at least between a proximal position, in which said constraining means is active on respective constraining portions of said first coupling body and said second coupling body and a distal position, in which said constraining means is not active on respective constraining portions of said first coupling body and said second coupling body;
a control unit configured to activate and/or deactivate at least said movement means and/or said constraining means and/or locking means on the basis of at least one operating parameter of said device and/or on the basis of a preloaded logic:
wherein said first body is a robotic arm and said second body is a reservoir adapted to contain at least one sterile product to be transferred to a filling line.

2. The device in accordance with claim 1, wherein said second coupling body defines at least one opening adapted to receive said first locking means and/or said second locking means by at least partial insertion; and wherein said first locking portion and said second locking portion define respective perimeter portions of said opening.

3. The device in accordance with claim 2, wherein said opening has a polygonal, preferably hexagonal, shape.

4. The device in accordance with claim 2, wherein said second locking body comprises a first pair of lead-in portions and a second pair of lead-in portions respectively converging towards said first locking portion and said second locking portion and configured to guide a movement of said first locking means and of said second locking means respectively towards said first locking portion and said second locking portion; and wherein said first pair of lead-in portions and/or said second pair of lead-in portions is defined by opposing perimeter portions of said opening.

5. The device in accordance with claim 1, wherein said first locking portion and said second locking portion are defined by opposing, preferably facing, portions, of said second locking body.

6. The device in accordance with claim 1, wherein said first locking means and/or said second locking means has portions that are complementarily shaped with respect to said first locking portion and/or to said second locking portion, respectively.

7. The device in accordance with claim 1, wherein said second locking means is reversibly movable away from and/or near to said first locking means in order to achieve said active configuration and/or said rest configuration.

8. The device in accordance with claim 1, wherein said locking means comprises at least one actuator configured to produce a relative movement between said first locking means and said second locking means.

9. The device in accordance with claim 1, wherein said constraining means comprises at least one quick-fit connection.

10. The device in accordance with claim 1, comprising at least one sensor adapted to detect and to generate at least one signal representative of at least one operating parameter of said device, preferably at least a relative positioning between the first coupling body and the second coupling body, and to send said signal to said control unit.

11. The device in accordance with claim 1, wherein said control unit configured to:
actuate said movement means so as to produce a relative movement between said first coupling body and said second coupling body; and/or
promote a reversable movement of said locking means between said active configuration and said rest configuration; and/or
activate and/or deactivate said constraining means so as to constrain and/or free the first body and the second body;
automatically on the basis of at least one operating parameter of said device and/or on the basis of a preloaded logic.

12. The device in accordance with claim 1, wherein said movement means comprises at least one robotic arm adapted to move said first coupling body and/or said second coupling body at least between said proximal position and said distal position.

13. The device in accordance with claim 11, wherein said robotic arm is connected to said first coupling body; and wherein said control unit is configured to activate said robotic arm automatically on the basis of at least one operating parameter of said device and/or on the basis of a preloaded logic.

14. The device in accordance with claim 1, wherein said constraining means comprises a spring-loaded shutter mounted on the second coupling body and/or a centring block mounted on the first coupling body operatively connected to substantially engage the first coupling body and the second coupling body.
